(19) United States
(12) Patent Application Publication
(10) Pub. No.: US 2025/0074254 A1
(43) Pub. Date: Mar. 6, 2025

(54) CONTROL DEVICE AND CONTROL METHOD

(71) Applicant: HONDA MOTOR CO., LTD., Tokyo (JP)

(72) Inventors: Takanori Michishita, Tokyo (JP); Daichi Ishida, Tokyo (JP); Masaomi Sato, Tokyo (JP); Shinji Takuno, Tokyo (JP)

(21) Appl. No.: 18/811,824

(22) Filed: Aug. 22, 2024

(30) Foreign Application Priority Data
Aug. 29, 2023 (JP) 2023-138796

(51) Int. Cl. B60L 58/24; B60W 60/00

(52) U.S. Cl. CPC B60L 58/24; B60W 60/001; B60L 2240/545; B60W 2510/244

(57) ABSTRACT

A control device of a vehicle includes a processor. The processor is configured to execute a program to acquire information indicating an operation state of the vehicle and a temperature of an electricity storage device, determine a target temperature range of the electricity storage device associated with the operation state, and control an operation of the electricity storage device on the basis of the temperature of the electricity storage device and the target temperature range. The operation state includes a first traveling state in which the vehicle is traveling without being in cooperation with a navigation device and a second traveling state in which the vehicle is traveling in cooperation with the navigation device, and the target temperature range associated with the second traveling state is narrower than the target temperature range associated with the first traveling state.

### CROSS-REFERENCE TO RELATED APPLICATION

Priority is claimed on Japanese Patent Application No. 2023-138796, filed Aug. 29, 2023, the content of which is incorporated herein by reference.

### BACKGROUND OF THE INVENTION

### Field of the Invention

The present invention relates to a control device and a control method.

### Description of Related Art

In recent years, research and development on secondary batteries that contribute to energy efficiency has been conducted to ensure that more people have access to affordable, reliable, sustainable, and advanced energy. For example, it is known to manage a battery temperature as a measure to suppress deterioration of batteries installed in electric vehicles. For example, a method is known in which a user selects a preferred mode among a plurality of preset charging and operation modes, and a temperature of a battery is maintained within a temperature range in accordance with the selected mode (refer to Japanese Patent No. 5055347).

### SUMMARY OF THE INVENTION

To maintain the battery at a target temperature, a lower limit value and an upper limit value of the battery temperature are preset, and the temperature of the battery is adjusted so that the temperature of the battery is maintained between these lower and upper limit values. However, when the lower and upper limit values of the battery temperature are uniformly set to the same value without considering a situation, the battery cannot be maintained at a target temperature, which may result in deteriorating of the battery and causing a problem with its durability.

The present invention has been made in consideration of these circumstances, and one of its objectives is to provide a control device and a control method that can suppress battery deterioration by appropriately switching a target temperature range of a battery depending on a situation. This will ultimately contribute to energy efficiency.

The control device and the control method according to the present invention employ the following configuration.

(1) A control device according to one aspect of the present invention is a control device of a vehicle that includes a rotating electric machine for driving a vehicle, an electricity storage device configured to transmit and receive power to and from the rotating electric machine, a temperature adjustment device configured to adjust a temperature of the electricity storage device, and a navigation device, and the control device includes a processor, in which the processor is configured to execute a program to acquire information indicating an operation state of the vehicle and a temperature of the electricity storage device, determine a target temperature range of the electricity storage device associated with the operation state, and control an operation of the electricity storage device on the basis of the temperature of the electricity storage device and the target temperature range. The operation state includes a first traveling state in which the vehicle is traveling without being in cooperation with the navigation device and a second traveling state in which the vehicle is traveling in cooperation with the navigation device, and the target temperature range associated with the second traveling state is narrower than the target temperature range associated with the first traveling state.

(2) In the control device according to the aspect of (1) described above, the second traveling state may be a state in which the vehicle is automatedly driven in cooperation with the navigation device.

(3) In the control device according to the aspect of (2) described above, the processor may be further configured to execute the program to control an automated driving of the vehicle, and switch an operation state of the vehicle from the second traveling state to the first traveling state when an operation state of the vehicle is the second traveling state and it is estimated that a temperature of the electricity storage device deviates from the target temperature range associated with the second traveling state.

(4) In the control device according to the aspect of (1) described above, the operation state may further include a charging state in which the electricity storage device is being charged.

(5) In the control device according to the aspect of (4) described above, the target temperature range associated with the second traveling state may be the same as the target temperature range associated with a state in which the electricity storage device is being charged with a direct current in the charging state.

(6) In the control device according to the aspect of (4) described above, the target temperature range associated with the first traveling state may be the same as the target temperature range associated with a state in which the electricity storage device is being charged with an alternating current in the charging state.

(7) In the control device according to the aspect of (4) described above, the target temperature range associated with the state in which the electricity storage device is being charged with a direct current in the charging state may be narrower than the target temperature range associated with the state in which the electricity storage device is being charged with an alternating current in the charging state.

(8) In the control device according to the aspect of any one of (1) to (7) described above, the processor may be further configured to execute the program to control the temperature adjustment device so that a temperature of the electricity storage device is included in the target temperature range.

(9) In the control device according to the aspect of (8) described above, the processor may be further configured to execute the program to acquire server information related to a destination of the vehicle or an area through which the vehicle is scheduled to travel from an external server, and control the temperature adjustment device on the basis of the acquired server information.

(10) In the control device according to the aspect of (3) described above, when the operation state of the vehicle is the second traveling state and the destination of the vehicle is a power supply facility, and pre-cooling control of the electricity storage device is performed by control of the temperature adjustment device, the processor may be configured to execute the program to maintain the operation state of the vehicle in the second traveling state even if the temperature of the electricity storage device deviates from the target temperature range associated with the second traveling state as a result of the pre-cooling control.

(11) A control method of a vehicle that includes a rotating electric machine for driving a vehicle, an electricity storage device configured to transmit and receive power to and from the rotating electric machine, a temperature adjustment device configured to adjust a temperature of the electricity storage device, and a navigation device includes, by a computer, acquiring information indicating an operation state of the vehicle and a temperature of the electricity storage device, determining a target temperature range of the electricity storage device associated with the operation state, and controlling an operation of the electricity storage device on the basis of the temperature of the electricity storage device and the target temperature range, in which the operation state includes a first traveling state in which the vehicle is traveling without being in cooperation with the navigation device and a second traveling state in which the vehicle is traveling in cooperation with the navigation device, and the target temperature range associated with the second traveling state is narrower than the target temperature range associated with the first traveling state.

(12) The control method according to the aspect of (11) described above further includes switching an operation state of the vehicle from the second traveling state to the first traveling state when an operation state of the vehicle is the second traveling state and it is estimated that a temperature of the electricity storage device deviates from the target temperature range associated with the second traveling state.

According to the above aspects (1) to (12), the target temperature range of the battery can be appropriately switched depending on the situation, thereby suppressing deterioration of the battery.

### BRIEF DESCRIPTION OF THE DRAWINGS

FIG. 1 is a diagram which shows an example of a configuration of a vehicle M according to an embodiment.

FIG. 2 is a functional block diagram which shows an example of a controller 40 according to the embodiment.

FIG. 3 is a flowchart which shows an example of a flow of temperature management processing for a battery 52 executed by the controller 40 according to the embodiment.

FIG. 4 is a diagram which shows an example of target temperature range information TD according to the embodiment.

FIG. 5 is a diagram which describes content of control by a battery controller 43 according to the embodiment.

### DETAILED DESCRIPTION OF THE INVENTION

Hereinafter, an embodiment of a control device and a control method of the present invention will be described with reference to the drawings. The control device of the embodiment controls an overall operation of an electric vehicle (hereinafter, “vehicle M”). The vehicle M is, for example, a two-wheeled, three-wheeled, or four-wheeled vehicle, and its driving source is a rotating electric machine (motor). The rotating electric machine operates using power generated by a generator connected to an internal combustion engine, or power discharged from a battery. Hereinafter, the vehicle M is assumed to be, for example, an electric vehicle that travels on an electric motor driven by power supplied from an on-board battery, such as a battery electric vehicle (BEV).

### Vehicle M

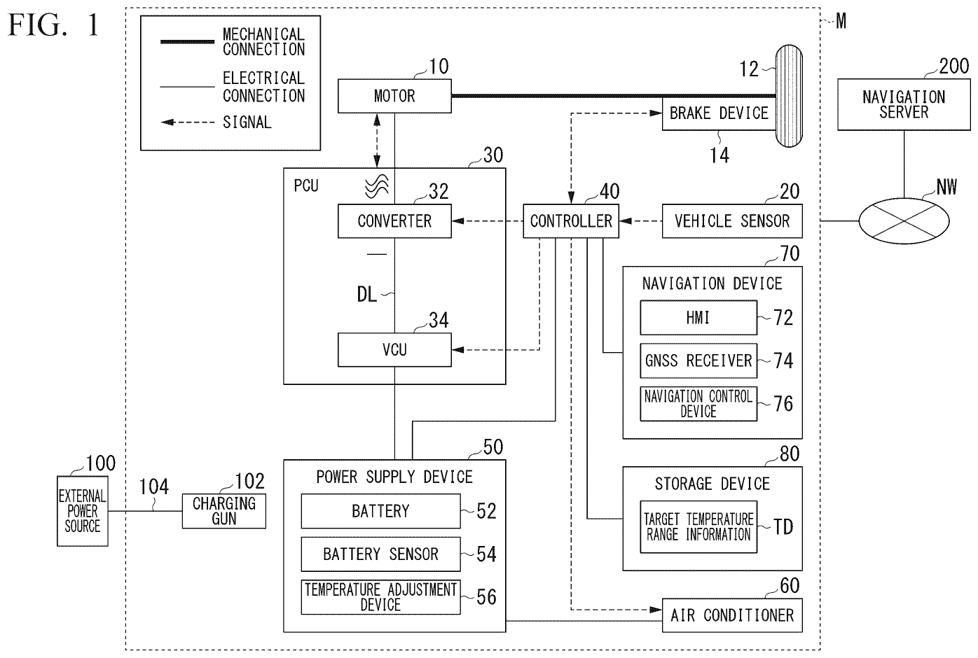

FIG. 1 is a diagram which shows an example of a configuration of a vehicle M according to an embodiment. The vehicle M includes, for example, a motor 10, a drive wheel 12, a brake device 14, a vehicle sensor 20, a power control unit (PCU) 30, a controller 40, a power supply device 50, an air conditioner 60, a navigation device 70, and a storage device 80. The power supply device 50 includes, for example, a battery 52, a battery sensor 54, and a temperature adjustment device 56. The vehicle M is an example of a “vehicle.” The motor 10 is an example of a “rotating electric machine” for driving the vehicle. The battery 52 is an example of an “electricity storage device” that transmits and receives power to or from the rotating electric machine. The temperature adjustment device 56 is an example of a “temperature adjustment device” that adjusts a temperature of the electricity storage device. The navigation device 70 is an example of a “navigation device.”

The motor 10 is, for example, a three-phase AC motor. A rotor of the motor 10 is connected to the drive wheels 12. The motor 10 outputs power to the drive wheel 12 using electricity supplied from the battery 52. The motor 10 also generates power using a kinetic energy of a vehicle when the vehicle decelerates.

The brake device 14 includes, for example, a brake caliper, a cylinder that transmits hydraulic pressure to the brake caliper, and an electric motor that generates hydraulic pressure in the cylinder. The brake device 14 may include, as a backup, a mechanism that transmits a hydraulic pressure generated by operating a brake pedal to the cylinder via a master cylinder. The brake device 14 is not limited to the configuration described above, and may be an electronically controlled hydraulic brake device that transmits a hydraulic pressure from the master cylinder to the cylinder.

The vehicle sensor 20 includes an accelerator opening sensor, a vehicle speed sensor, and a brake depression sensor. The accelerator opening sensor is attached to the accelerator pedal, which receives an acceleration command from a driver. The accelerator opening sensor detects an amount of operation of the accelerator pedal, and outputs the detected amount of operation to the controller 40 as an accelerator opening. The vehicle speed sensor includes, for example, wheel speed sensors attached to each wheel and a speed calculator. The vehicle speed sensor integrates wheel speeds detected by the wheel speed sensors to derive a vehicle speed (vehicle speed), and outputs the derived speed information to the controller 40. The brake depression sensor is attached to the brake pedal. The brake depression sensor detects the amount of operation of the brake pedal, and outputs the detected amount of operation to the controller 40 as a brake depression.

The PCU 30 includes, for example, a converter 32 and a voltage control unit (VCU) 34. The converter 32 is connected between the battery 52 and the motor 10. The converter 32 converts power output by the VCU 34 into power corresponding to the motor 10 and supplies it to the motor 10. The converter 32 is, for example, an AC-DC converter. A direct current side terminal of the converter 32 is connected to a direct current link DL. The battery 52 is connected to the direct current link DL via the VCU 34. The converter 32 converts an alternating current generated by the motor 10 into a direct current and outputs it to the direct current link DL.

The VCU 34 is connected between the battery 52 and the motor 10. The VCU 34 boosts or lowers the power supplied from the battery 52 and outputs it to the direct current link DL. The VCU 34 is, for example, a DC-DC converter.

The controller 40 controls an overall operation of the vehicle M. The controller 40 controls the motor 10 and the brake device 14 on the basis of, for example, information output by the vehicle sensor 20. In addition, the controller 40 controls the VCU 34 to adjust the power supplied to the motor 10 on the basis of, for example, information output by the vehicle sensor 20. The controller 40 also determines the target temperature range of the battery 52 and controls the temperature adjustment device 56 according to the determined target temperature range. Moreover, the controller 40 controls automated driving of the vehicle M in cooperation with the navigation device 70.

Each of functional units of the controller 40 is realized by a computer processor such as an electronic control unit (ECU) or a central processing unit (CPU) executing a program (software). Each of the functional units of the controller 40 may be realized by hardware (a circuit unit) such as a large scale integration (LSI), an application specific integrated circuit (ASIC), a field-programmable gate array (FPGA), or a graphics processing unit (GPU), or may be realized by software and hardware in cooperation. Each of the functions of the controller 40 may be incorporated into a separate control device, such as a motor ECU, a brake ECU, or a battery VCU ECU. The functions of the controller 40 will be described in detail below.

The battery 52 supplies power to various parts mounted on the vehicle M. The battery 52 is, for example, a battery pack including a power storage unit (not shown) that stores power used for the vehicle M to travel. The battery 52 may be, for example, configured to be easily detachable from the vehicle M such as a cassette-type battery pack, or may be configured to be a stationary type that is not easily detachable from the vehicle M. The power storage unit (not shown) included in the battery 52 is, for example, a rechargeable secondary battery such as a lithium-ion battery. The secondary battery included in the battery 52 may be, for example, a capacitor such as an electric double layer capacitor, or a composite battery that combines a secondary battery and a capacitor, in addition to a lead-acid battery, a nickel-metal hydride battery, a sodium ion battery. The battery 52 can be charged by power provided by an external power source 100 that is a charger outside the vehicle M. The battery 52 may be a fuel cell stack (FCS).

The battery sensor 54 measures physical quantities such as a current, a voltage, and a temperature of the battery 52. The battery sensor 54 includes, for example, a current sensor, a voltage sensor, and a temperature sensor. The battery sensor 54 measures the temperature of the battery 52 under control of the controller 40, and outputs information indicating the measured temperature to the controller 40. The battery sensor 54 also measures the current and voltage of the battery 52 and outputs information indicating the measured current and voltage to the controller 40.

The temperature adjustment device 56 adjusts, for example, the temperature of the battery 52 under the control of the controller 40. The temperature adjustment device 56 is, for example, a heat exchanger (chiller) that exchanges heat between a heat medium and an air-conditioning heat medium. The heat medium is, for example, water, radiator liquid, coolant liquid, or the like. The air-conditioning heat medium is, for example, fluorocarbon or a substitute for fluorocarbon.

The air conditioner 60 adjusts a temperature inside the vehicle M in response to the control of the controller 40 based on an instruction input by an occupant of the vehicle M via, for example, an input interface (not shown).

The navigation device 70 includes, for example, a human machine interface (HMI) 72, a global navigation satellite system (GNSS) receiver 74, and a navigation control device 76. The HMI 72 includes, for example, a touch panel display device, a speaker, a microphone, and the like. The GNSS receiver 74 measures a position of a host vehicle (the position of the vehicle M) on the basis of radio waves arriving from a GNSS satellite (for example, a GPS satellite). The navigation control device 76 includes, for example, a central processing unit (CPU) and various storage devices, and controls an entire navigation device 70. The storage device stores map information (navigation map). The navigation map is a map that represents roads with nodes and links. The navigation control device 76 determines a route from the position of the vehicle M measured by the GNSS receiver 74 to a destination specified using the HMI 72 by referring to the navigation map. In addition, the navigation control device 76 may transmit the position and the destination of the vehicle M to the navigation server 200 using a communication device (not shown) and acquire a route returned from the navigation server 200. The navigation control device 76 outputs route information of the route determined by any of the methods described above to the controller 40.

The storage device 80 stores various types of information necessary for controlling the vehicle M. The storage device 80 stores, for example, the target temperature range information TD of the battery 52. The storage device 80 is realized by an electrically erasable programmable read only memory (EEPROM), a read only memory (ROM), a random access memory (RAM), or the like. At least a part of the information included in the storage device 80 may be stored in an external device capable of communicating with the vehicle M.

The external power source 100 supplies power to the battery 52 of the vehicle M. The external power source 100 includes, for example, a charging cable 104 and a charging gun 102 connected to the charging cable 104. The charging gun 102 is connected to a charging port (not shown) provided on a body of the vehicle M by an occupant of the vehicle M, or the like. The external power source 100 supplies power to the battery 52 of the vehicle M via the charging cable 104 and the charging gun 102, thereby charging the battery 52. Alternatively, the charging cable may be provided on the body, or the like, so that it can be drawn out to the outside of the vehicle M. A first end of both ends of the charging cable is fixed to the vehicle M, and a second end of the both ends of the charging cable 104 is provided with a charging plug. The charging plug is connected to a receptacle of the external power source 100, which may be, for example, a household outlet (hardware plug socket).

The navigation server 200 transmits route information to the vehicle M in response to a request from the vehicle M via a communication network NW. In addition, the navigation server 200 transmits, to the vehicle M, the distance to the destination of the vehicle M (for example, a charging facility), and a weather forecast (temperature), road surface information, and the like of an area through which the vehicle M passes.

### Configuration of Controller 40

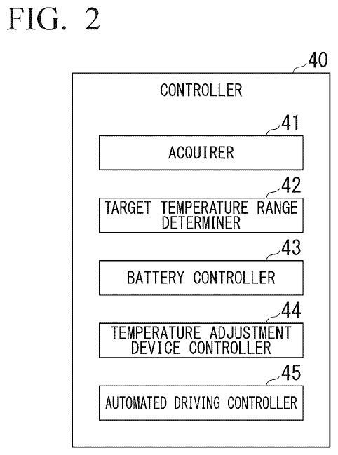

FIG. 2 is a functional block diagram which shows an example of the controller 40 according to the embodiment. The controller 40 includes, for example, an acquirer 41, a target temperature range determiner 42, a battery controller 43, a temperature adjustment device controller 44, and an automated driving controller 45.

The acquirer 41 acquires various information related to the vehicle M. For example, the acquirer 41 acquires information on the temperature of the battery 52 measured by the battery sensor 54. The acquirer 41 also acquires information indicating an operation state of the vehicle M, such as information indicating whether the vehicle M is traveling, information indicating whether the vehicle M is traveling in cooperation with the navigation device 70, a speed of the vehicle M, an outside air temperature of the vehicle M, and information indicating whether the vehicle M is being charged (information indicating a charging state in which the vehicle M is connected to a charging gun 102 to be charged). The acquirer 41 also acquires information from the navigation server 200, such as a destination of the vehicle M (for example, a new charging facility), a route to the destination, a distance to the destination, a weather forecast (temperature) and road surface information for an area through which the vehicle M passes. The acquirer 41 is an example of an “acquirer.” The operation state includes a first traveling state in which the vehicle M is traveling without being in cooperation with the navigation device 70, and a second traveling state in which the vehicle M is traveling in cooperation with the navigation device 70. The second traveling state is a state in which the vehicle M is automated driving in cooperation with the navigation device. Alternatively, this second traveling state may be a state in which route guidance is displayed on a display device (not shown) provided in the vehicle M in cooperation with the navigation device.

The target temperature range determiner 42 determines a target temperature range of the battery 52 associated with an operation information on the basis of the acquired operation information related to the operation of the vehicle M and the target temperature range information TD stored in the storage device 80. The target temperature range determiner 42 is an example of a “target temperature range determiner.” The target temperature range associated with the second traveling state in which the vehicle is traveling in cooperation with the navigation device 70 is narrower than the target temperature range associated with the first traveling state in which the vehicle is traveling without being in cooperation with the navigation device 70. Processing of the target temperature range determiner 42 will be described in detail below.

The battery controller 43 controls the operation of the battery 52 on the basis of the temperature of the battery 52 acquired by the acquirer 41 and the target temperature range determined by the target temperature range determiner 42. For example, when the acquired temperature of the battery 52 deviates from the determined target temperature range, the battery controller 43 controls an output of the battery 52 to reduce or stop the output of the battery 52. The battery controller 43 is an example of an “electricity storage device controller.” Processing of the battery controller 43 will be described in detail below.

The temperature adjustment device controller 44 controls the temperature adjustment device 56. For example, the temperature adjustment device controller 44 controls the temperature adjustment device 56 so that the acquired temperature of the battery 52 is within the determined target temperature range. The temperature adjustment device controller 44 is an example of a “temperature adjustment device controller.” Details of processing of the temperature adjustment device controller 44 will be described below.

The automated driving controller 45 controls the automated driving of the vehicle M. For example, the automated driving controller 45 performs automated driving of the vehicle M to the destination in cooperation with the navigation device 70. The automated driving controller 45 is an example of an “automated driving controller.” When the operation state of the vehicle M is the second traveling state and it is estimated that the temperature of the battery 52 will deviate from the target temperature range associated with the second traveling state, the automated driving controller 45 switches the operation state of the vehicle M from the second traveling state to the first traveling state. Details of the processing of the automated driving controller 45 will be described below.

### Processing Flow

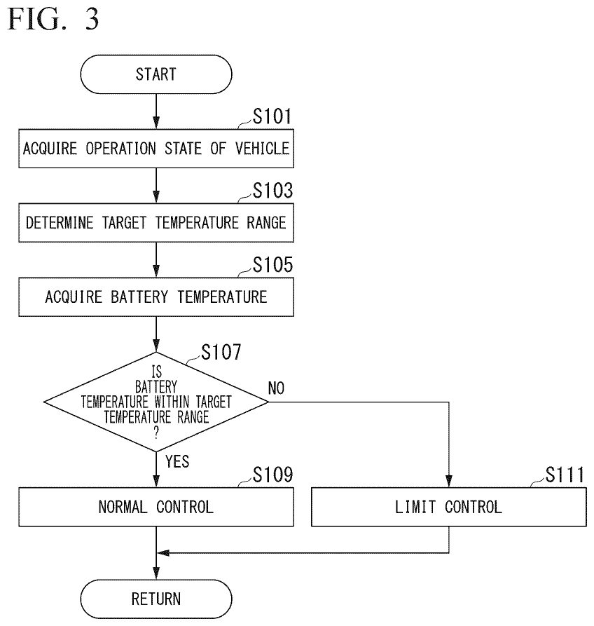

Next, an example of temperature management processing of the battery 52 centered on an operation of the controller 40 will be described. FIG. 3 is a flowchart which shows an example of a flow of the temperature management processing of the battery 52 executed by the controller 40 according to the embodiment.

First, the acquirer 41 acquires information indicating the operation state of the vehicle M (step S101). The information indicating the operation state of the vehicle M includes, for example, information indicating whether the vehicle M is traveling, information indicating whether the vehicle M is traveling in cooperation with the navigation device 70, information indicating whether the vehicle M is being charged, and the like.

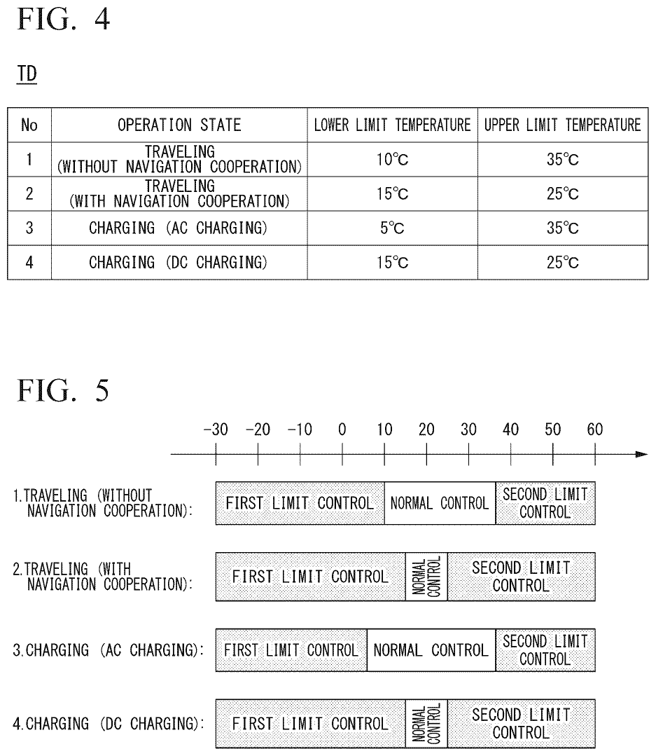

Next, the target temperature range determiner 42 determines the target temperature range of the battery 52 on the basis of the acquired information indicating the operation state of the vehicle M and the target temperature range information TD stored in the storage device 80 (step S103). FIG. 4 is a diagram which shows an example of the target temperature range information TD according to the embodiment. For example, when the acquired information indicating the operation state of the vehicle M indicates a state in which the vehicle is traveling without being in cooperation with the navigation device 70, the target temperature range determiner 42 determines a range in which the lower limit temperature is “10° C.” and the upper limit temperature is “35° C.,” that is, a range of 10 to 35° C., associated with “No. 1: Traveling (without navigation cooperation)” in FIG. 4, as the target temperature range. In addition, for example, when the acquired information indicating the operation state of the vehicle M indicates a state in which the vehicle M is traveling in cooperation with the navigation device 70, the target temperature range determiner 42 determines a range in which the lower limit temperature is “15° C.” and the upper limit temperature is “25° C.,” that is, a range of 15 to 25° C., associated with “No. 2: Traveling (with navigation cooperation)” in FIG. 4 as the target temperature range. In this manner, the target temperature range associated with “No. 2: Traveling (with navigation cooperation)” is determined to be narrower than the target temperature range associated with “No. 1: Traveling (without navigation cooperation).”

Moreover, for example, when the acquired information indicating the operation state of the vehicle M indicates that the vehicle is being charged with an alternating current (being charged slowly), the target temperature range determiner 42 determines a range in which the lower limit temperature is “5° C.” and the upper limit temperature is “35° C.,” that is, a range of 5 to 35° C., associated with “No. 3: Being charged (AC charging)” in FIG. 4 as the target temperature range. This target temperature range associated with “No. 3: Being charged (AC charging)” may be the same as the target temperature range associated with “No. 1: Traveling (without navigation cooperation)”.

In addition, for example, when the acquired information indicating the operation state of the vehicle M indicates that the vehicle is being charged with a direct current (being charged rapidly), the target temperature range determiner 42 determines the range in which the lower limit temperature is “15° C.” and the upper limit temperature is “25° C.,” that is, a range from 15 to 25° C., associated with “No. 4: Being charged (DC charging)” in FIG. 4 as the target temperature range. This target temperature range associated with “No. 4: Being charged (DC charging)” may be the same as the target temperature range associated with “No. 2: Traveling (with navigation cooperation).” Moreover, the target temperature range associated with the state in which the vehicle is being charged with a direct current is narrower than the target temperature range associated with the state in which the vehicle is being charged with an alternating current.

Next, the acquirer 41 acquires the temperature of the battery 52 measured by the battery sensor 54 (step S105). Next, the battery controller 43 determines whether the acquired battery temperature is within the determined target temperature range (step S107).

When it is determined that the acquired battery temperature is within the determined target temperature range (YES in step S107), the battery controller 43 performs normal control that does not limit the output of the battery 52 (step S109). On the other hand, when it is determined that the acquired battery temperature is not within the determined target temperature range (NO in step S107), the battery controller 43 performs limit control that reduces or stops the output of the battery 52 (step S111).

FIG. 5 is a diagram which describes content of the control by the battery controller 43 according to the embodiment. As shown in FIG. 5, when the operation state of the vehicle M is “No. 1: Traveling (without navigation cooperation),” normal control is performed within the target temperature range (10 to 35° C.), and limit control is performed outside the target temperature range. The limit control includes a first limit control when the temperature is below the target temperature range (10 to 35° C.), and a second limit control when the temperature is above the target temperature range. In the first limit control and the second limit control, the output from the battery 52 is reduced or the output is stopped. In the first limit control and the second limit control, the output from the battery 52 may be restricted to a greater extent as a degree of deviation from the target temperature range increases. The content of the limits in the first limit control may be different from the content of the limit in the second limit control.

In addition, as shown in FIG. 5, when the operation state of the vehicle M is “No. 3: Being charged (AC charging),” normal control is performed within the target temperature range (5 to 35° C.), and limit control is performed outside the target temperature range. In normal control, charging of the battery 52 is not limited. The limit control includes a first limit control when the temperature is below the target temperature range (5 to 35° C.) and a second limit control when the temperature is above the target temperature range. In the first limit control and the second limit control, a charging time of the battery 52 is limited. For example, in the first limit control and the second limit control, the charging time of the battery 52 is limited to be longer (to be charged slowly). In the first limit control and the second limit control, the charging time of the battery 52 may be limited to be longer as the degree of deviation from the target temperature range increases. The content of the limit in the first limit control and the content of the limit in the second limit control may be different.

Moreover, under the normal control and limit control described above, the temperature adjustment device controller 44 controls the temperature adjustment device 56 in parallel. For example, when the acquired temperature of the battery 52 is not included in the determined target temperature range, the temperature adjustment device controller 44 controls the temperature adjustment device 56 so that the temperature of the battery 52 is included in the target temperature range. Under the first limit control when the temperature is below the target temperature range, the temperature adjustment device controller 44 controls the temperature adjustment device 56 so that the battery 52 is heated. On the other hand, under the second limit control when the temperature is above the target temperature range, the temperature adjustment device controller 44 controls the temperature adjustment device 56 so that the battery 52 is cooled. Moreover, for example, even when the acquired temperature of the battery 52 is included in the determined target temperature range, the temperature adjustment device controller 44 controls the temperature adjustment device 56 so that the temperature of the battery 52 is less likely to deviate from the target temperature range (for example, so that the temperature of the battery 52 approaches a middle value of the target temperature range).

Furthermore, under the normal control described above, when the operation state of the vehicle M is “No. 2: Traveling (with navigation cooperation)” and it is estimated that the temperature of the battery 52 will deviate from the associated target temperature range (when the temperature is approaching the lower or upper limit of the target temperature range), the automated driving controller 45 switches the driving state of the vehicle M from “No. 2: Traveling (with navigation cooperation)” to “No. 1: Traveling (without navigation cooperation). By performing such control, it is possible to prevent a situation in which the temperature of the battery 52 deviates from the target temperature range.

The acquirer 41 may further acquire server information related to the destination of the vehicle M or the area through which the vehicle M is scheduled to travel from an external navigation server 200, and the temperature adjustment device controller 44 may control the temperature adjustment device 56 on the basis of the acquired server information. For example, when a distance to a charging facility acquired as server information is short, the temperature adjustment device controller 44 performs control to lower the temperature of the battery 52 in preparation for a charging operation (taking into consideration that the temperature of the battery 52 will rise during the charging operation). In addition, for example, when the temperature of the area through which the vehicle M will pass, which is acquired as server information, is high (or low), the temperature adjustment device controller 44 adjusts the temperature of the battery 52 such that it is lowered (raised). By performing such control, it is possible to avoid a situation in which the temperature of the battery 52 deviates from the target temperature range.

In addition, the temperature adjustment device controller 44 may cause the temperature adjustment device 56 to perform pre-cooling control to cool the battery 52 on the basis of information on the destination of the vehicle M. For example, when the operation state of the vehicle M is a state in which the vehicle is traveling in cooperation with the navigation device 70 and the destination of the vehicle M is a power supply facility (a rapid charging spot), the temperature adjustment device controller 44 may cause the temperature adjustment device 56 to perform pre-cooling control to cool the battery 52. Here, when the pre-cooling control is performed, the automated driving controller 45 may maintain the operation state of the vehicle M in a state in which the vehicle is traveling in cooperation with the navigation device 70, even if the temperature of the battery 52 deviates from the target temperature range as a result of the pre-cooling control.

After the series of processing described above is performed, the processing returns to step S101 again and the subsequent processing is repeated. For example, when the operation state of the vehicle M acquired in step S101 is different from the previous operation state, control is performed according to the latest operation state after the change.

According to the present embodiment described above, battery deterioration can be suppressed by appropriately controlling a target temperature range of a battery depending on a situation (an operation state) in which a vehicle operates.

Although the present invention has been described above using an embodiment, the present invention is not limited to such an embodiment, and various modifications and substitutions can be made within a range not departing from the gist of the present invention.

What is claimed is:

1. A control device of a vehicle that comprises a rotating electric machine for driving a vehicle, an electricity storage device configured to transmit and receive power to and from the rotating electric machine, a temperature adjustment device configured to adjust a temperature of the electricity storage device, and a navigation device, the control device comprising a processor configured to execute a program to:
acquire information indicating an operation state of the vehicle and a temperature of the electricity storage device;
determine a target temperature range of the electricity storage device associated with the operation state; and
control an operation of the electricity storage device on the basis of the temperature of the electricity storage device and the target temperature range,
wherein the operation state includes a first traveling state in which the vehicle is traveling without being in cooperation with the navigation device and a second traveling state in which the vehicle is traveling in cooperation with the navigation device, and
the target temperature range associated with the second traveling state is narrower than the target temperature range associated with the first traveling state.

2. The control device according to claim 1,
wherein the second traveling state is a state in which the vehicle is automatedly driven in cooperation with the navigation device.

3. The control device according to claim 2,
wherein the processor is further configured to execute the program to:
control an automated driving of the vehicle, and
switch an operation state of the vehicle from the second traveling state to the first traveling state when an operation state of the vehicle is the second traveling state and it is estimated that a temperature of the electricity storage device deviates from the target temperature range associated with the second traveling state.

4. The control device according to claim 1,
wherein the operation state further includes a charging state in which the electricity storage device is being charged.

5. The control device according to claim 4,
wherein the target temperature range associated with the second traveling state is the same as the target temperature range associated with a state in which the electricity storage device is being charged with a direct current in the charging state.

6. The control device according to claim 4,
wherein the target temperature range associated with the first traveling state is the same as the target temperature range associated with a state in which the electricity storage device is being charged with an alternating current in the charging state.

7. The control device according to claim 4,
wherein the target temperature range associated with the state in which the electricity storage device is being charged with a direct current in the charging state is narrower than the target temperature range associated with the state in which the electricity storage device is being charged with an alternating current in the charging state.

8. The control device according to claim 1,
wherein the processor is further configured to execute the program to:
control the temperature adjustment device so that a temperature of the electricity storage device is included in the target temperature range.

9. The control device according to claim 8,
wherein the processor is further configured to execute the program to:
acquire server information related to a destination of the vehicle or an area through which the vehicle is scheduled to travel from an external server; and
control the temperature adjustment device on the basis of the acquired server information.

10. The control device according to claim 3,
wherein, when the operation state of the vehicle is the second traveling state and the destination of the vehicle is a power supply facility, and pre-cooling control of the electricity storage device is performed by control of the temperature adjustment device, the processor is configured to execute the program to maintain the operation state of the vehicle in the second traveling state even if the temperature of the electricity storage device deviates from the target temperature range associated with the second traveling state as a result of the pre-cooling control.

11. A control method of a vehicle that comprises a rotating electric machine for driving a vehicle, an electricity storage device configured to transmit and receive power to and from the rotating electric machine, a temperature adjustment device configured to adjust a temperature of the electricity storage device, and a navigation device, the control method comprising:
by a computer,
acquiring information indicating an operation state of the vehicle and a temperature of the electricity storage device,
determining a target temperature range of the electricity storage device associated with the operation state, and
controlling an operation of the electricity storage device on the basis of the temperature of the electricity storage device and the target temperature range,
wherein the operation state includes a first traveling state in which the vehicle is traveling without being in cooperation with the navigation device and a second traveling state in which the vehicle is traveling in cooperation with the navigation device, and
the target temperature range associated with the second traveling state is narrower than the target temperature range associated with the first traveling state.

12. The control method according to claim 11, further comprising:
switching an operation state of the vehicle from the second traveling state to the first traveling state when an operation state of the vehicle is the second traveling state and it is estimated that a temperature of the electricity storage device deviates from the target temperature range associated with the second traveling state.
